(19) United States
(12) Patent Application Publication
(10) Pub. No.: US 2026/0286762 A1
(43) Pub. Date: Sep. 24, 2026

(54) IMPACT-RESISTANT SECTIONAL OVERHEAD DOOR

(71) Applicant: DuraServ LLC, Carrollton, TX (US)

(72) Inventors: Sean Fernando, Seville, OH (US); Eddie Johnston, Dalton, OH (US); David Newcomer, Massillon, OH (US)

(21) Appl. No.: 19/558,242

(22) Filed: Mar. 5, 2026

Related U.S. Application Data
(60) Provisional application No. 63/774,343, filed on Mar. 19, 2025.

(51) Int. Cl. E06B 3/48

(52) U.S. Cl. CPC E06B 3/488

(57) ABSTRACT

An impact-resistant sectional overhead door comprising a plurality of panels with a first panel comprising a panel body without intervening vertical support between a first end and second end, and a tube comprising a plurality of walls configured to form a groove at each corner of the tube, with each groove being configured to receive a seal such as weatherstripping to seal an opening around a portion of the door. The grooves may be uniform, such that the same tube may be used in multiple different applications or configurations. The tube may be formed from a fiberglass material with a polyurethane resin base.

### TECHNICAL FIELD

The present disclosure relates to an impact-resistant sectional overhead door, such as a garage door. Because garage doors are one common example of such an overhead door, the disclosure may refer to “overhead doors” and “garage doors” interchangeably, but notwithstanding any such references, one of ordinary skill in the art will understand that the disclosure is not limited to a door that is specifically used at the entrance to a garage, as opposed to any other type of structure.

### BACKGROUND

An overhead door such as a garage door may be used to control access to an opening used for heavy machinery (e.g., a car in a residential setting; forklifts in a commercial setting). As a result, these doors are highly susceptible to impacts while in use. Conventional garage doors are significantly damaged and may not be operational if impacted. This can result in significant downtime. If the door is not operational, the door will either be left open, leaving the contents within the building susceptible to damage or theft, or be left closed, limiting access. Therefore, a garage door that is impact-resistant is needed to allow continued operation after impacts to reduce downtime.

Plastics such as polyethylene and polyurethane became a popular material choice in the late 1930s. Plastics are easy to clean, easy to maintain, impact-resistant, corrosion resistant, eco-friendly, and water-resistant.

Polyethylene has a lower specific gravity than steel, resulting in a lighter product, which makes transportation and installation easier. Despite polyethylene's low specific gravity, polyethylene still has comparable strength and durability to steel. Further, as polyethylene processes developed, plastic became a more cost-effective option than steel, and polyethylene can be easily recycled. Although polyethylene is slightly weaker and less durable than steel, the additional benefits of polyethylene make it a competitive material choice. Further, polyethylene can be used as a resin that may be blended with additives. These additives can increase the strength and durability of polyethylene, and overcome some of polyethylene's shortcomings in comparison to steel.

In some applications, it may be desired for users to have visibility through a door. Certain conventional garage doors may have opaque construction or windows, which may provide limited visibility. In some applications, it may be desired for a door to provide increased or full visibility through a garage door. Further, it may be desired for a garage door to provide visibility while providing a desired level of impact resistance. Therefore, what is desired is a garage door that is impact-resistant, but allows for increased or full visibility in certain applications.

### SUMMARY

In one embodiment, a sectional overhead door may comprise a plurality of panels including a first panel comprising a panel body having a first end and a second end, a first vertical reinforcement adjacent to the first end, a second vertical reinforcement adjacent to the second end, wherein the panel body extends between the first vertical reinforcement and the second vertical reinforcement without an intervening vertical support between the first vertical reinforcement and the second vertical reinforcement; and a tube connected to the first panel and configured to receive a seal, the tube comprising a plurality of walls comprising a first wall, a second wall perpendicular to the first wall, a third wall parallel to the first wall, a fourth wall parallel to the second wall, a first corner wall coupling the first wall to the second wall, wherein the first corner wall, the first wall, and the second wall cooperatively define a first groove, a second corner wall coupling the second wall to the third wall, wherein the second corner wall, the second wall, and the third wall cooperatively define a second groove, a third corner wall coupling the third wall to the fourth wall, wherein the third corner wall, the third wall, and the fourth wall cooperatively define a third groove, and a fourth corner wall coupling the fourth wall to the first wall, wherein the fourth corner wall, the fourth wall, and the first wall cooperatively define a fourth groove, wherein the tube is comprised of a fiberglass material with a polyurethane resin base.

In another embodiment, the first panel body may comprise a transparent material, which may comprise polycarbonate.

In another embodiment, the sectional overhead door may further comprise a second panel, and the tube may be disposed between the first panel and the second panel.

In certain embodiments, a movable barrier assembly is provided comprising a plurality of door panels arranged vertically to form a door surface, wherein the door surface comprises a width. The assembly further comprises a plurality of cross-tubes extending horizontally across the door surface and coupled to the panels, each cross-tube comprising a fiber composite body having a cross-section, wherein the cross-section is substantially the same for each of the plurality of cross-tubes, and wherein each cross-tube comprises a rectangular profile and a seal member groove at each longitudinally-extending corner. In some aspects, the movable barrier design described above is configured to limit deflection of the door to an amount that is within the plastic limits of the materials used for the panels, including the fiber composite body. In one such example, the garage door assembly deflects less than one inch per horizontal foot of the width of the door surface under a wind load corresponding to a 160 mph wind speed without the use of intermediate vertical stiffeners between the panels.

In some forms, the fiber composite body comprises a pultruded fiberglass body.

In certain implementations, each of the cross tubes comprises a first end portion and a second end portion opposite the first end portion, wherein the first end portion is configured to interface with a first roller assembly, and wherein the second end portion is configured to interface with a second roller assembly. In such implementations, the assembly further comprises a first rail on a first lateral side of the movable barrier, and a second rail on a second lateral side of the movable barrier, wherein the first roller assembly is configured to engage the first rail, and wherein the second roller assembly is configured to engage the second rail.

In some embodiments, at least one of the plurality of door panels comprises a clear span of at least 80% of the width of the door. In certain examples, the at least one of the plurality of door panels comprises a flat panel member exhibiting a visible light transmittance (VLT) of at least 80%.

In particular embodiments, the width of the door surface is between 12 feet and 16 feet, and wherein the garage door assembly deflects no more than 11 inches under the wind load corresponding to the 160 mph wind speed.

### BRIEF DESCRIPTION OF DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 is an exemplary embodiment of an impact-resistant overhead door.

FIG. 2A is an exemplary embodiment of a non-insulated panel structure that may be used in an impact-resistant overhead door such as that shown in FIG. 1.

FIG. 2B is an exemplary embodiment of an insulated panel structure that may be used in an impact-resistant overhead door such as that shown in FIG. 1.

FIG. 3 is a side perspective of a universal pultruded fiberglass tube with weatherstripping.

FIG. 4 is a cross sectional view of a universal pultruded fiberglass tube.

FIG. 5 is an exemplary embodiment of an impact-resistant panel that may be used in an impact-resistant overhead door such as that shown in FIG. 1.

FIG. 6A is a cross sectional view of a universal pultruded fiberglass tube having reinforced walls according to an embodiment of the present disclosure.

FIG. 6B is a cross sectional view of a universal pultruded fiberglass tube having reinforced walls according to an embodiment of the present disclosure.

FIG. 7 is an exemplary embodiment of an edge-supported, impact-resistant overhead door.

FIG. 8A is a perspective view of an edge-supported, impact-resistant overhead door prior to experiencing a simulated wind load.

FIG. 8B is a perspective view of an edge-supported, impact-resistant overhead door during a simulated wind load.

FIG. 9A is a plan view of a universal pultruded fiberglass tube having two corner groove features according to an embodiment of the present disclosure.

FIG. 9B is a perspective view of the universal pultruded fiberglass tube of FIG. 9A.

FIG. 10A is a plan view of a universal pultruded fiberglass tube having two corner groove features according to another embodiment of the present disclosure.

FIG. 10B is a perspective view of the universal pultruded fiberglass tube of FIG. 10A.

### DETAILED DESCRIPTION

The present disclosure relates generally to a garage door, and more particularly, to an impact-resistant garage door. As described herein, embodiments of the impact-resistant garage door improve upon conventional garage doors.

Conventionally, garage doors allow the passage of large vehicles or equipment. In some instances, the garage doors are at risk of being hit while in use. Conventional garage doors are significantly damaged and may not be operational if impacted. Therefore, it is desired for garage doors to provide a construction that is impact-resistant and able to continue function or operation after impacts.

Further, in some applications, it may be desired for users to have visibility through a door. Certain conventional garage doors may have opaque construction or windows, which may provide limited visibility. In some applications, it may be desired for a door to provide increased or full visibility through a garage door. Further, it may be desired for a garage door to provide visibility while providing a desired level of impact resistance.

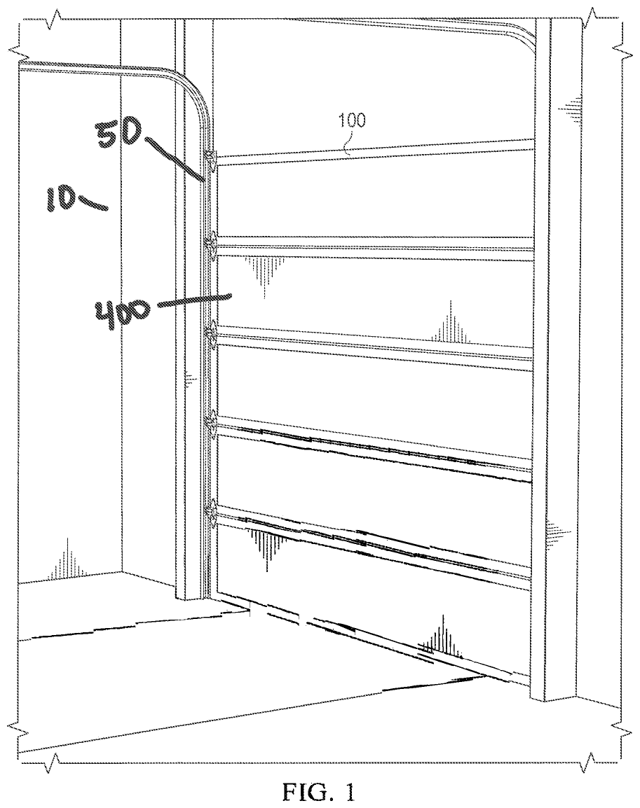

Referring to FIG. 1, an exemplary embodiment of an overhead door 10 is shown. In the depicted example, the overhead door 10 comprises a plurality of panel structures 400. In certain applications, the panel structures 400 can extend from one end of the door opening to the other end of the door opening with no intermediate vertical support. In certain embodiments, the plurality of panel structures 400 are coupled together with a plurality of universal tubes 100 (U-tubes), the structure of which is discussed below in further detail, as well as in co-pending U.S. patent application Ser. No. 18/627,680, the full disclosure of which is hereby incorporated by reference.

Advantageously, the U-tubes can be used as a compression seal between door panels as well as between the bottom door panel and the floor. In certain applications, the U-tubes can be used to provide an attachment point for insulation to the door panels. Embodiments of the U-tubes include design features to allow for easy installation and maintenance, and flexible operation of this equipment. Certain embodiments of the U-tubes can be tailored to use with a garage door. In the depicted example, the plurality of panel structures 400 are coupled with the plurality of universal tubes 100 such that the panel structures 400 are positioned within a plurality of tracks 50. In certain applications, the overhead door 10 may be compatible with multiple track options including: standard lift tracks, hi-lift tracks, and vertical lift tracks.

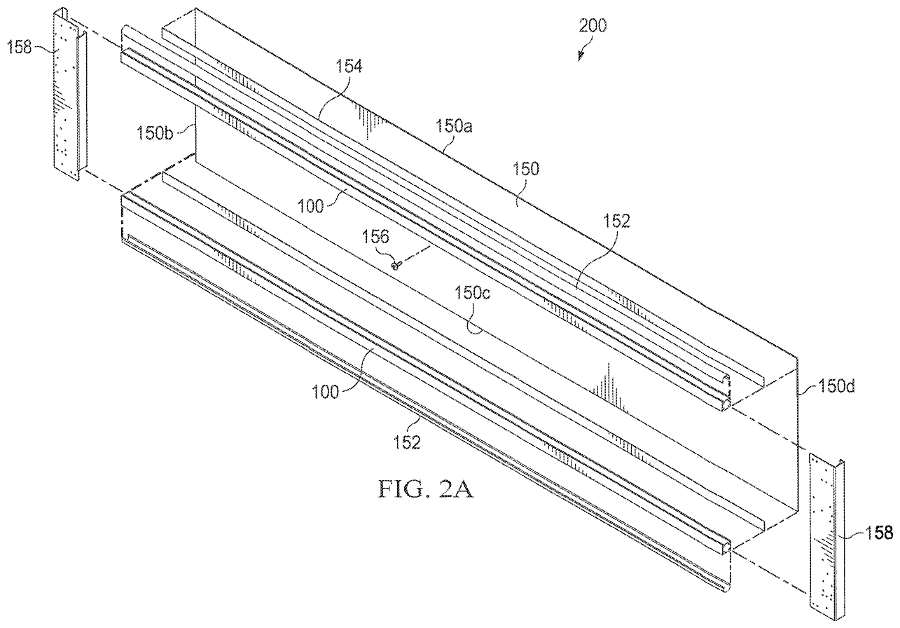

Referring to FIG. 2A, an exemplary embodiment of a non-insulated panel structure 200 is shown. In the depicted example, the non-insulated panel structure 200 includes a panel 150 coupled to a plurality of U-tubes 100. Each U-tube 100 may receive a seal 152, which provides a compression seal between the panel 150 and adjacent structures. Advantageously, the U-tube 100 is configured to receive a seal in multiple configurations, as will be discussed in more detail below. As illustrated, the panel 150 has a rectangular configuration with a top edge 150a, a left edge 150b, a bottom edge 150c, and a right edge 150d. In certain embodiments, the top edge 150a and bottom edge 150c have lengths greater than the height of the left edge 150b and right edge 150d.

As illustrated, an end cap 158 receives the left edge 150b of the panel. Advantageously, the end cap 158 reinforces and protects the left edge 150b of the panel. As illustrated, an end cap 158 receives the right edge 150d of the panel. Advantageously, the end cap 158 reinforces and protects the right edge 150d of the panel. In some embodiments, the end caps 158 are made of steel. As will be discussed in more detail below, the U-tube 100 is comprised of four walls. In the depicted example, the U-tube 100 can be coupled to the panel 150. For example, a wall of the U-tube 100 can be coupled to an edge of the panel 150 with structural tape 154 and a single bolt 156. A person of ordinary skill in the art will understand that other methods could be used to couple the U-tube 100 to the panel 150. As illustrated, a first U-tube 100 can be coupled to the top edge 150a of the panel and a second U-tube 100 can be coupled to the bottom edge 150c of the panel 150. Advantageously, the U-tube 100 has the same orientation whether it is attached to the top edge 150a of the panel 150 or the bottom edge 150c.

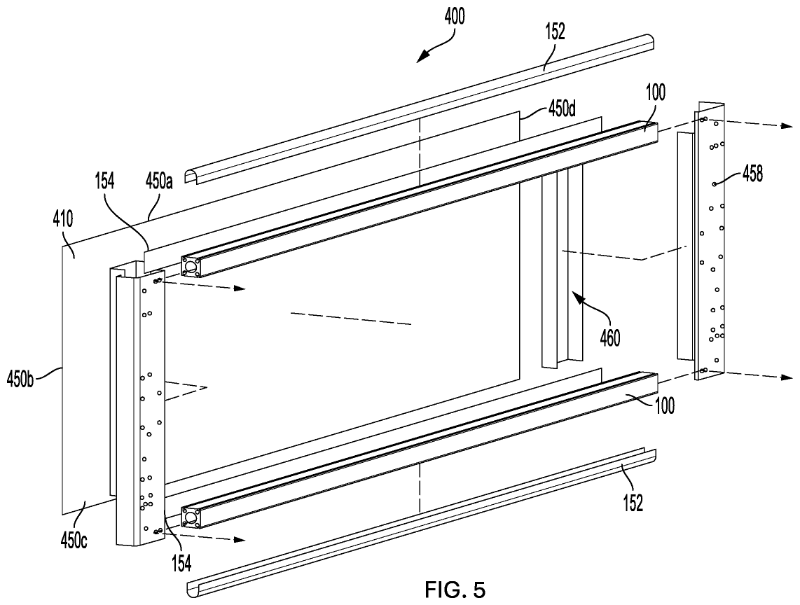

Referring to FIG. 2B, an exemplary embodiment of an insulated panel structure 300 is shown. In the depicted example, the insulated panel structure 300 includes a central panel 350, an interior insulating panel 360, and an exterior insulating panel 370. The interior insulating panel 360 and the exterior insulating panel 370 are coupled to a U-tube 100. The U-tube 100 receives a seal 152, which provides a compression seal between the panel 350 and adjacent structures. Advantageously, the U-tube 100 is configured to receive a seal in multiple configurations, as will be discussed in more detail below. Similar to the panel 150 shown above, the panel 350 has a rectangular configuration with a top edge 350a, a bottom edge 350c, a left edge 350b, and a right edge 350d. In certain embodiments, the top edge 350a and bottom edge 350c have lengths greater than the height of the left edge 350b and right edge 350d. In certain embodiments the panel 350 is made of an expanded polystyrene (EPS) material and is at least 3 mm thick. In some embodiments, the panel 350 can be as thick as 1-1.5 inches (or about 2-4 cm). In certain applications, impact-resistant panel 410 discussed with respect to FIG. 5, may comprise a panel substantially consistent with panel 150 shown in FIG. 2A.

As illustrated in FIG. 2B, each component of insulated panel structure 300 may have a substantially rectangular configuration. Accordingly, interior insulating panel 360 may have a top edge 360a, a bottom edge 360c, a left edge 360b, and a right edge 360d. In certain embodiments, the top edge 360a and bottom edge 360c have lengths greater than the height of the left edge 360b and right edge 360d. Similarly, the exterior insulating panel 370 may have a top edge 370a, a bottom edge 370c, a left edge 370b, and a right edge 370d. In certain embodiments, the top edge 370a and bottom edge 370c have lengths greater than the height of the left edge 370b and right edge 370d. In this embodiment, the interior insulating panel 360 and exterior insulating panel 370 have a plurality of holes along the top edges 360a and 370a and the bottom edges 360c and 370c extending from the left edges 360b and 370b to the right edges 360d and 370d.

Advantageously, the holes along the top edge and the bottom edge of the interior insulating panel 360 and the exterior insulating panel 370 may align with holes positioned along the length of U-tubes 100. As illustrated, a first U-tube 100 can be coupled to the top edges 360a and 370a of the interior insulating panel 360 and exterior insulating panel 370 respectively and a second U-tube 100 can be positioned along the bottom edges 360c and 370c of the interior insulating panel 360 and exterior insulating panel 370 respectively. Advantageously, as discussed in further detail below, each U-tube 100 has the same orientation whether it is positioned along the top edges 360a and 370a of the interior insulating panel 360 and exterior insulating panel 370 respectively or the bottom edges 360c and 370c of the interior insulating panel 360 and exterior insulating panel 370 respectively. In this embodiment, the holes of the interior panel 360, exterior panel 370, and U-tube 100 receive a bolt so that the interior insulating panel 360 and the exterior insulating panel 370 can be coupled to the U-tube 100 such that the U-tube 100 is sandwiched between the interior insulating panel 360 and the exterior insulating panel 370. In some embodiments, the interior insulating panel 360 and the exterior insulating panel 370 are coupled to the U-tube 100 with structural tape. A person of ordinary skill in the art would understand that insulating panels 360 and 370 can be coupled to the U-tube 100 using various methods, including fasteners, thermal welds, adhesives, retaining recesses, or any other suitable methods.

As illustrated, an end cap 158 receives the left edge 350b of central panel 350, as well as the left edge of the interior insulating panel 360, and the left edge of the exterior insulating panel 370. Advantageously, the end cap 158 reinforces and protects the left edge 350b of the panel 350, the edge of the interior insulating panel 360, and the edge of the exterior insulating panel 370. As illustrated, an end cap 158 receives the left edge 350c of the central panel 350, as well as the right edge of the interior insulating panel 360, and the right edge of the exterior insulating panel 370. Advantageously, the end cap 158 reinforces and protects the right edge 350d of the panel 350, the edge of the interior insulating panel 360, and the edge of the exterior insulating panel 370. In certain applications, impact-resistant panel 410 discussed with respect to FIG. 5, may comprise a panel substantially consistent with insulated panel structure 300 shown in FIG. 2B. In such an embodiment, certain modifications may be made, such as replacing end cap 158 with end cap 458 and reinforcement insert 460.

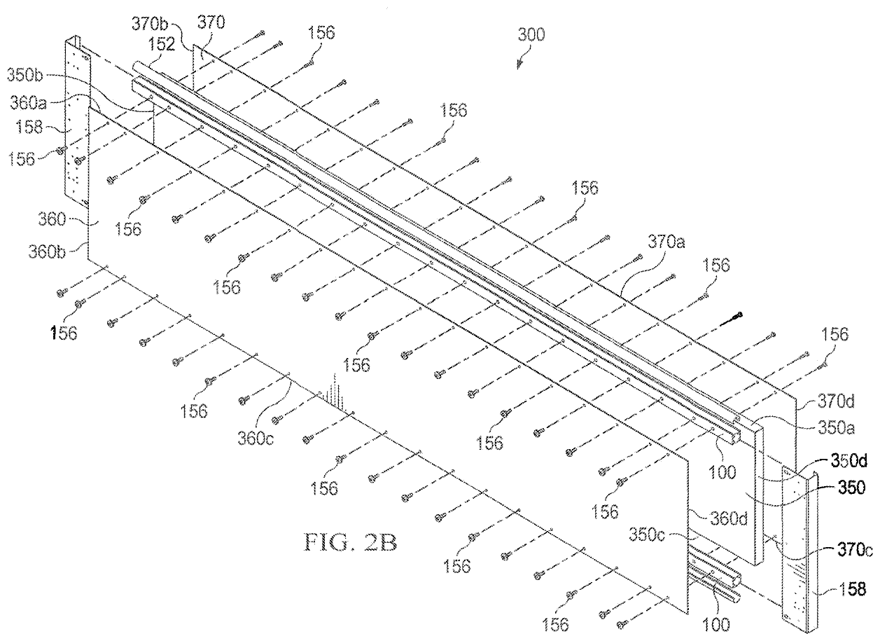

As illustrated in FIG. 3 and as discussed above, the U-tube 100 is configured to receive a seal 152. As will be discussed in further detail below, the U-tube 100 has a set of grooves that are configured to receive the seal 152. In some embodiments, the seal is a joint seal. In some embodiments, the seal is a thermoplastic vulcanizate (TPV) seal. In other embodiments, the seal is an ethylene propylene diene monomer (EPDM) seal.

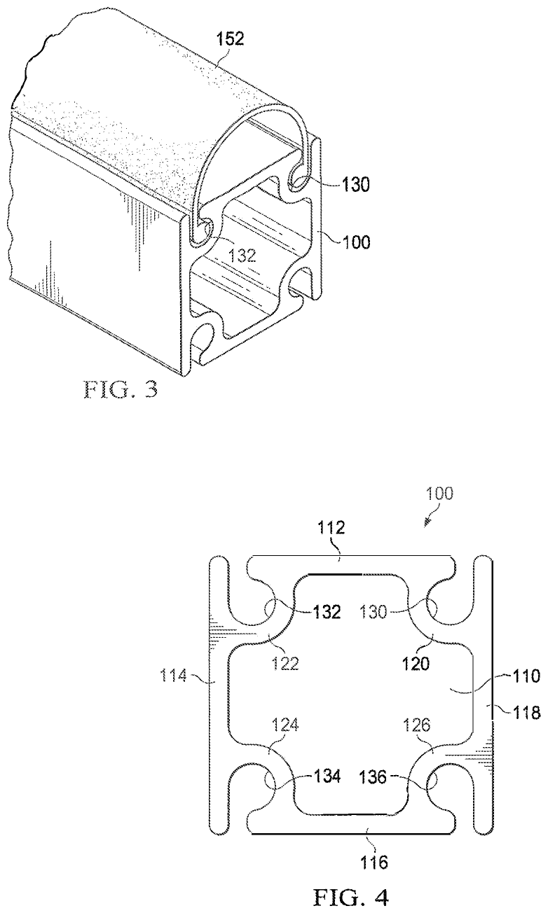

Referring to FIG. 4, a cross-sectional view of the U-tube 100 is shown. As discussed above, the U-tube 100 is a universal tube and can be used in a range of applications. For example, the U-tube can be used between the door and the floor as well as between door panels. In the depicted example, the U-tube 100 includes a plurality of walls. The U-tube 100 includes a first wall 112, a second wall 114, a third wall 116, and a fourth wall 118. In this embodiment, the first wall 112 and third wall 116 are of equal length. The second wall 114 and the fourth wall 118 are of a second equal length. In certain embodiments, the second wall 114 and fourth wall 118 are approximately 1.5 inches long. In this embodiment, the length of the first wall 112 and third wall 116 is less than the length of the second wall 114 and the fourth wall 118. The first wall 112, second wall 114, third wall 116, and fourth wall 118 are arranged to form a rectangular shape such that the second wall 114 is perpendicular to the first wall 112 and the third wall 116 is parallel to the first wall 112. As illustrated in FIG. 4, the plurality of walls do not touch. In this embodiment, the plurality of walls are connected by a plurality of corner walls. As illustrated in FIG. 4, a first corner wall 122 couples the first wall 112 to the second wall 114, wherein the first wall 112, the second wall 114, and the first corner wall 122 define a first groove 132. A second corner wall 124 couples the second wall 114 to the third wall 116 in a similar manner, wherein the second wall 114, the third wall 116, and the second corner wall 124 define a second groove 134. A third corner wall 126 couples the third wall 116 to the fourth wall 118 in a similar manner, wherein the third wall 116, the fourth wall 118, and the third corner wall 126 define a third groove 136. A fourth corner wall 120 couples the fourth wall 118 to the first wall 112 in a similar manner, wherein the first wall 112, the fourth wall 118, and the fourth corner wall 120 define a fourth groove 130. In this embodiment, the plurality of walls and plurality of corner walls define an internal cavity 110. The first groove 132, the second groove 134, the third groove 136, and the fourth groove 130 are equal in size and shape. The grooves 132, 134, 136, and 130 are defined to have a rounded hook shape with a straight section extending to a circular section. In this embodiment, the circular section has a radius of ⅛ inch. Advantageously, the grooves 132, 134, 136, and 130 are designed to receive a seal. In some embodiments, the seal extends through the straight section of the groove and then curls or hooks into the circular section such that the seal is secured to the U-tube 100.

Advantageously, the first wall 112, the second wall 114, the third wall 116, the fourth wall 118, the first corner wall 122, the second corner wall 124, the third corner wall 126, and the fourth corner wall 120 all have a uniform thickness. In certain embodiments, the plurality of walls are 1/10 inch thick. In certain embodiments, the U-tube 100 is made of a fiberglass material. In some embodiments, the fiberglass material is formed in a pultrusion process with a polyurethane resin base. Advantageously, the polyurethane resin base may improve the strength of the U-tube and may allow for U-tubes of extended lengths up to 20 feet or more.

Advantageously, the U-tube allows for universal applications. For example, many conventional compression seals are limited to sealing applications between a door and the floor. Because the U-tube has identical grooves defined at all four corners, it is not limited in its application. This flexibility may reduce manufacturing costs, allow for a more aesthetically pleasing product, and reduce the inventory needed for door applications.

Referring to FIG. 5, an exemplary embodiment of an impact-resistant panel structure 400 is shown. In the depicted example, the impact-resistant panel structure 400 includes an impact-resistant panel 410. Similar to panel 150 depicted in FIG. 2A, the impact-resistant panel 410 has a rectangular configuration with a top edge 450a, a left edge 450b, a bottom edge 450c, and a right edge 450d. In certain embodiments, the top edge 450a and the bottom edge 450c extend from a first end of a door opening to an opposite end of a door opening. In certain embodiments, a flexible but high impact-resistant material is chosen for the panel 410 such that the door can elastically deform and return to an operational state or configuration after impact. Advantageously, the panel structure 400 is impact-resistant without the use of intermediate vertical supports, allowing for a continuous panel to extend from one end of a door opening to the opposite end of a door opening.

In certain embodiments, the panel 410 material comprises a recycled polyethylene core laminated with a smooth, high impact skin. In certain embodiments, the skin is made from 0.012 grade 80 KSI steel, G90 galvanized, and is 3 mm thick. In certain embodiments, the exterior of the panel 410 is a high-gloss polar white, achieved through a baked-on polyester paint system. In some embodiments, the panel 410 includes one or more windows. In certain embodiments, the window comprises a transparent material, including, but not limited to polycarbonate. Polycarbonate is a strong and lightweight plastic that has high impact resistance. Polycarbonate can also be transparent. This makes polycarbonate a suitable material for applications where impact resistance and visibility are desired.

In some embodiments, the polycarbonate substrate can be approximately 0.24 inches thick. In certain embodiments, the window is the entire panel 410. The panel 410 comprises a transparent material, including, but not limited to polycarbonate. Advantageously, the use of polycarbonate or other suitable materials allows for a substrate and panel that is transparent and impact-resistant. Advantageously, the panel 410 can withstand impacts of objects weighing up to 1,200 pounds.

As illustrated in FIG. 5, an end cap 458 and reinforcement insert 460 receive the left edge 450b of the panel. Advantageously, the end cap 458 and reinforcement insert 460 reinforce and protect the left edge 450b of the panel. As illustrated, an end cap 458 and reinforcement insert 460 receive the right edge 450d of the panel. Advantageously, the end cap 458 and reinforcement insert 460 reinforce and protect the right edge 450d of the panel. In some embodiments, the end caps 458 and reinforcement inserts 460 are made of steel. In some embodiments, the end caps and reinforcement inserts are made of 14-gauge hot-dip galvanized steel. As discussed in more detail above, the U-tube 100 is comprised of four walls. In the depicted example, the U-tube 100 can be coupled to the panel 410 in the same manner as discussed with respect to FIG. 2A. Alternatively, U-tube 100 may be coupled to panel 410 in a similar manner as that shown in FIG. 2A, but with certain differences. For example, impact-resistant panel structure 400 may not include a bolt similar to bolt 156 shown in FIG. 2A. The U-tube provides additional impact resistance to the panel and door as discussed in further detail below.

Because U-tube 100 may be formed of an impact-resistant material such as fiberglass formed in a pultrusion process with a polyurethane resin base, the strength of the U-tube 100 provides structural support to the panels, allows for compression between the panels, and reduces the transfer of load between the panels. Accordingly, the panel 410 may extend from the end cap 458 and reinforcement insert 460 along edge 450b to the end cap 458 and reinforcement insert 460 along edge 450c without an intermediate vertical support in between edge 450a and edge 450d. In some applications, the U-tube can withstand a deflection of up to 18 inches without permanent damage.

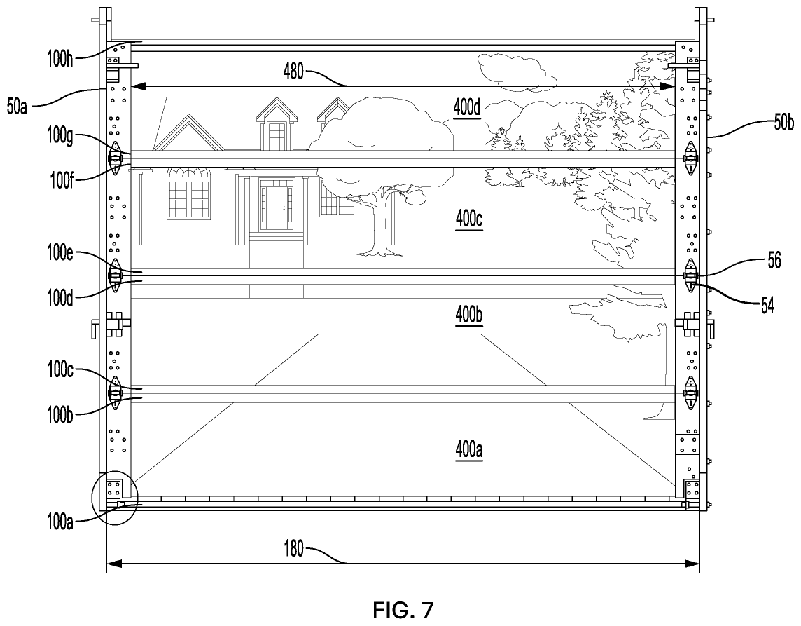

In some aspects, the end caps 458 couple to the U-tubes 100 at respective end portions of the U-tube. The end caps 458 may be similar or analogous to the end caps 158 shown in FIG. 2B. The end caps 458 provide a mounting structure to which hinges (see 54, FIG. 7) and roller assemblies (see 56, FIG. 7) are coupled or attached. Accordingly, the end portions of the U-tubes 100 are indirectly coupled to the hinges 54 and roller assemblies 56. In other words, the hinges 54 and roller assemblies 56 are indirectly coupled to the U-tubes 100 adjacent the corresponding end portions of the U-tubes 100. In other embodiments, the hinges 54, the roller assemblies 56, or both may be directly coupled to the end portions of the U-tubes.

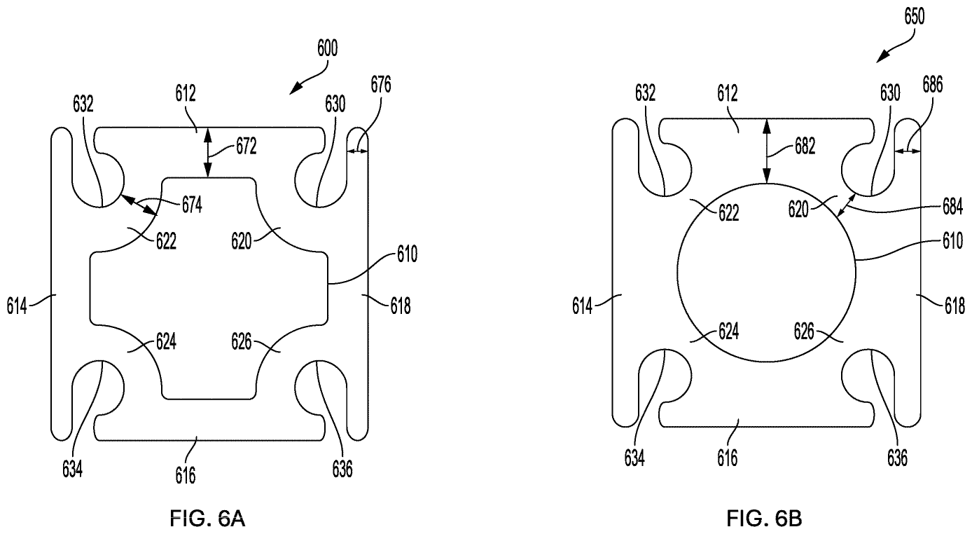

FIGS. 6A and 6B illustrate exemplary alternative embodiments of a universal tube (600, 650) that, in various implementations, may be used interchangeably with the universal tube 100 previously described with reference to FIGS. 3-5. The embodiments in FIGS. 6A and 6B may have some similar or replicated functional geometry of the rounded hook-shaped grooves at each corner and preserve the universal orientation feature while increasing structural rigidity by thickening the side walls and corner walls. For ease of reference, the universal tube embodiments of FIGS. 6A and 6B use similar numerical identifiers for features corresponding to those of the universal tube 100 described above.

In one embodiment shown in FIG. 6A, the universal tube 600 includes a first wall 612, a second wall 614 perpendicular to the first wall 612, a third wall 616 parallel to the first wall 612, and a fourth wall 618 parallel to the second wall 614. Corner walls 622, 624, 626, and 620 couple adjacent walls and cooperatively define grooves 632, 634, 636, and 630, respectively, at the four corners. The corner grooves are shaped as rounded hooks with a straight throat portion that transitions into a circular capture profile, which is sized to receive and retain a compliant seal 672. The corner groove geometry is similar, and in some embodiments identical, to the universal tube 100 geometry to maintain compatibility with seals, panel interfaces, and floor interfaces previously described. In this embodiment, the internal cavity 610 exhibits a rounded “cross” shape, produced by the thicker wall sections and corner radii. As explained in more detail below, the thicker wall thicknesses in the embodiments of FIGS. 6A and 6B may increase the strength and rigidity of the universal tubes relative to the tube 100 described above.

In some aspects, the wall thicknesses of the embodiment shown in 6A are generally uniform, including the thickness of the corners, grooves, and lateral walls. For instance, with reference to the tube 600 shown in FIG. 6A, the thickness 672 may be equal to, or nearly equal to (e.g., +/−10%) the thickness 674 at the corner 622. The thickness 676 is shown substantially less than the thicknesses 672 and 674, which may provide desirable flexibility of the corner flanges while providing increased overall strength due to the increased thicknesses 672, 674. In other embodiments, the thickness 676 is greater than what is shown in FIG. 6A. For instance, the thickness 676 may be equal to or greater than the thickness 672 and/or the thickness 674. In other embodiments, the wall thicknesses may be increased in one or more regions to achieve desired performance characteristics. For instance, in some embodiments, the material thickness 674 of one or more of the corner walls 622, 624, 626, and 620 may be greater than the thickness 672 of the lateral walls 612, 614, 616, 618, or vice versa. Further, it will be understood that the interior corners may be rounded (e.g., filleted) in some embodiments, like the embodiment shown in FIG. 4. In some embodiments, the material thickness is increased in the regions that experience stress concentrations during flexion of the tube 600 in various directions.

In another embodiment shown in FIG. 6B, the universal tube 650 likewise includes walls 612, 614, 616, and 618 and corner walls 622, 624, 626, and 620 forming grooves 632, 634, 636, and 630 at the four corners. In this embodiment, the internal cavity 610 is circular (cylindrical). In both FIGS. 6A and 6B, the side walls and corner walls have an increased thickness relative to the thickness exemplified for universal tube 100, further raising stiffness and strength while preserving the four-way groove functionality and identical orientation in top and bottom panel positions. In the embodiment of FIG. 6B, the tube 650 has significantly greater thickness 682 in the lateral side wall regions compared to the thickness 684 at the corner regions. The thickness 686 is shown as being less than that of the side wall region (thickness 682). However, in other embodiments, the thickness 686 may be increased to match or exceed the thickness 682, as explained above.

In certain embodiments, the universal tube embodiments of FIGS. 6A and 6B are pultruded fiberglass tubes with a polyurethane resin base, as previously described for tube 100. The increased wall thickness may be specified, for example, by a nominal wall gauge that is 10-40% greater than the nominal wall thickness of tube 100, with a tolerance suitable for pultrusion processes. Non-limiting examples of performance advantages achievable with the 600 series include reduced mid-span deflection under uniform static air pressure, improved resistance to cyclic flexure, and increased energy absorption under impact, all without sacrificing the universal seal-receiving capability at each corner groove. The thicker wall and corner sections may also facilitate high localized crush resistance at hanger, hinge, and fastener interfaces, distributing fastener loads and reducing the likelihood of stress concentrations or micro-cracking in highly loaded zones.

In various implementations, the seal is a joint seal. For instance, the seal may include a TPV seal, an EPDM bulb, and/or a fin seal dimensioned to couple into any of grooves 630, 632, 634, and 636 so that the identical tube cross-section can function at a panel-to-panel interface or at a panel-to-floor interface. The four-corner groove arrangement preserves the universal, orientation-agnostic usage and reduces manufacturing and inventory complexity. In certain embodiments, the tubes are provided in common lengths, including, but not limited to, lengths appropriate for door widths of approximately 6 feet to 16 feet, and may be produced at lengths up to 20 feet or more.

When used at the top and bottom of each panel of the overhead door 10, the relatively thicker universal tubes shown in FIGS. 6A-6B may provide for a door assembly that is fully edge-supported, such that each panel has a clear span extending substantially the full length of the panel without intermediate vertical support structures. A clear span door assembly may have a width of 8 feet, 12 feet, 16 feet, or even more than 16 feet, incorporating transparent panel sheets (e.g., polycarbonate, glass) allowing for a full view through the door without obstructions by intermediate vertical supports. The full-view door assembly provides a useful and visually-appealing door that has the strength and resiliency to withstand strong winds.

Applicants have tested the disclosed assembly and confirmed that the design allows for outstanding performance in harsh conditions, while maintaining a visually-appealing full-view appearance. For one specific example, in a uniform static air pressure test conducted in accordance with ASTM E 330/E330M and ANSI/DASMA 108, a door measuring 146 inches wide by 96 inches high, constructed using universal tubes 650 shown in FIG. 6B at the top and bottom of each panel, and having four panel sections each 146 inches by 24 inches and incorporating ¼-inch clear polycarbonate exterior skins with pultruded fiberglass support tubes and standard roller/track hardware, was evaluated at design loads of +30 psf and −34.2 psf. The assembly exhibited peak mid-span deflections on the order of approximately 7.0 inches at +30 psf and approximately 6.9 inches at −34.2 psf, with no visible signs of failure and with the door remaining operable upon test completion, and at elevated load steps the maximum recorded deflections reached about 11.0 inches (positive 45 psf) and about 9.4 inches (negative 51.3 psf), respectively. Additional aspects of the assembly and its performance characteristics are described below.

FIG. 7 shows a movable barrier or overhead door 10 comprising a plurality of vertically arranged panel assemblies 400a, 400b, 400c, and 400d. The panel assemblies 400a-400d may each be the panel 400 shown in FIG. 5. In some embodiments, one or more aspects of the panel assemblies 400a-400d may differ from the panel 400 shown in FIG. 5. For instance, the panel assemblies 400a-400d may use universal tubes that are similar or identical to one of the tubes 600 or 650 shown in FIGS. 6A and 6B, respectively. Each panel assembly spans horizontally between opposing jambs with a clear span 480. The term “clear span” refers to the unobstructed horizontal distance between opposing lateral supports of an opening or structure, such as the side jambs of a garage door frame. As used herein in connection with the door panel sections disclosed, a panel section having a clear span or free span is one in which the panel body extends laterally from a first vertical edge to an opposing second vertical edge with support provided at the edges—e.g., by the top and bottom universal tubes and by the left and right end caps interfacing to the rails 50a, 50b—such that no intermediate vertical stile is present within the viewing area. In some aspects, the rails 50a, 50b may be referred to as tracks. The rails 50a, 50b are configured to receive corresponding rollers or roller assemblies coupled to the panels 400 to allow the overhead door 10 to rollably slide along the track, as would be familiar to a POSITA. The panels 400 are aligned and arranged vertically, which, for the purpose of the present disclosure, may also be referred to as a vertically-stacked arrangement.

As shown, all or a large majority (e.g., more than 80%, more than 90%) of the span 180 of the door 10 is free of vertical supports, other than the support provided by the panel member (substrate) itself. In illustrative embodiments, the clear span 480 may be on the order of 5.5 to 15.5 feet, with one non-limiting example being about 11.5 feet. The overall door width 180 may range from approximately 6 feet to approximately 16 feet, with an exemplary embodiment having a width of about 12 feet. In certain embodiments designed for commercial or residential applications, the door width 180 can be 16 feet or more while preserving functional performance (e.g., according to the standardized criteria discussed below) without intermediate vertical stiles. Each panel includes, as shown in FIG. 5, a panel member (410), which may also be referred to as a panel sheet, a substrate, or tile.

Each panel assembly 400 has a universal tube 100 at its top edge and a universal tube 100 at its bottom edge. As depicted, the bottom-most panel assembly 400a includes a bottom universal tube 100a and a top universal tube 100b; the adjacent panel assembly 400b includes a bottom universal tube 100c, and so forth through 100h. The universal tubes 100a-100b may include the universal tube 100, or either of the universal tubes 600, 650 shown in FIGS. 6A-6B. In an exemplary embodiment, the universal tubes 600 are consistent with the embodiment 600 shown in FIG. 6A, such that the increased wall thickness provides for increased strength and resistance to wind and impacts. For the panel assembly 400a, the tubes 100a-100b provide structural reinforcement, seal retention, and standardized mechanical interfaces to both the panel bodies and the track-mounted hardware. In the closed position, opposing seals carried in the facing grooves of adjacent universal tubes may compress to form an inter-panel seal. In other variations, a small gap may be provided and then closed by seal compression under static door weight, latch preload, or pressure differentials.

An appreciable feature of the assembly is the absence of intermediate vertical support structures (stiles) within the panel bodies, thereby maintaining a clear span and allowing the panel bodies to be fabricated from transparent or translucent materials to produce a see-through door. Aesthetically, eliminating intermediate vertical stiles yields an expansive, uniform visual field across each panel section. In other words, by relocating primary structural reinforcement to the top and bottom universal tubes of each panel assembly and using robust end caps at the panel edges, the panel body presents a clear or light-transmitting, unobstructed aperture with enhanced aesthetics, while preserving the stiffness needed to limit deflection under load. Transparent panel bodies, such as clear polycarbonate, provide full visibility, while translucent or partially opaque variants enable privacy glazing that admits natural light. The universal tube's compact, symmetrical cross-section and uniform seal detail at each corner preserve a sleek, consistent sightline between adjacent panels and at the floor interface. Together, these features enable clean, see-through designs that meet stringent structural demands without compromising visual transparency.

In certain embodiments, the panel members or substrates are transparent polycarbonate sheets having a thickness of approximately 0.24 inches (about 6 mm) with high impact resistance and optical clarity. For instance, such sheets may exhibit a visible light transmittance (VLT) of approximately 80-95% and a haze of about 1-5% when measured per recognized industry methods (e.g., ASTM D1003), with co-extruded UV-protective layers or hardcoats configured to block most (e.g., 90%-99.9%) of UV-A/UV-B and optional reflective or low-emissivity coatings to improve solar control. Other implementations may use acrylic (PMMA), tempered glass, laminated safety glass, multiwall or solid polycarbonate, glass-fiber reinforced polymer (FRP/GRP) translucent panels, or engineered privacy/diffusing panels. In non-limiting examples: translucent diffusing panels may provide VLT of about 10-70% with haze of at least about 80% (ASTM D1003) to admit daylight while obscuring detail; privacy glazing may target VLT of about 5-30%; and opaque panels may have VLT of not more than about 1%. In other embodiments, the panel members may have a greater or small thickness, ranging from, e.g., about 0.125 inches to about 0.5 inches, allowing for manufacturing tolerances or for corresponding thickness options in the metric scale.

In some embodiments, end caps and reinforcement inserts at the panel vertical edges provide localized reinforcement and protect the panel edges inside the track-and-roller system. Suitable end caps may be fabricated from galvanized steel, and may be configured as wrap-around end caps that distribute fastener loads and present a smooth, durable interface to the rollers. Hardware such as rollers, hinges, brackets, and slide locks may be standardized as shown in the associated component drawings, with steel rollers and high-strength shafts positioned at each hinge location.

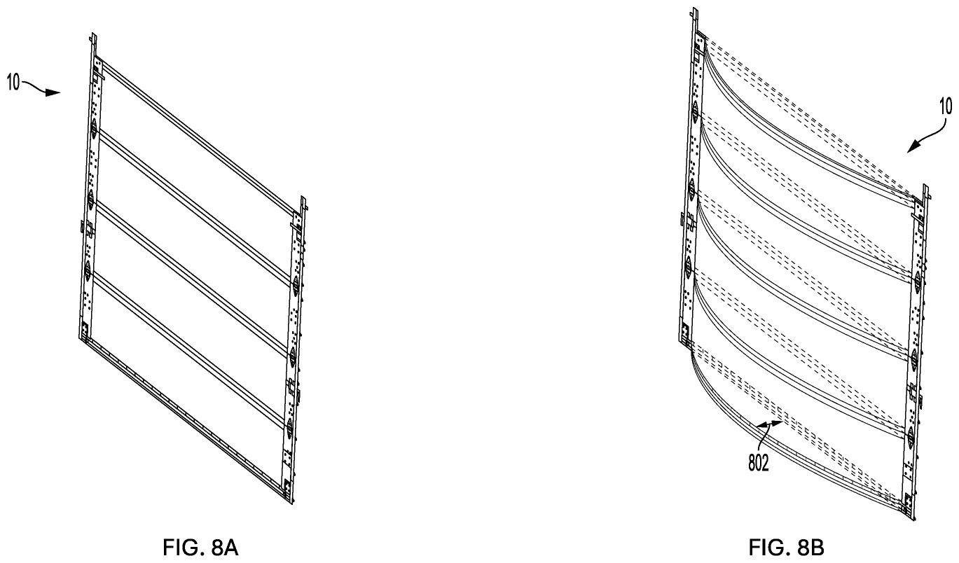

FIGS. 8A and 8B depict the overhead door 10 under quiescent conditions and under wind loading, respectively. FIG. 8A illustrates the door 10 in a substantially planar state. FIG. 8B depicts deflection 802 of the door in response to a uniform static air pressure difference applied across the surface of the door. It will be understood that the illustrations in FIGS. 8A and 8B are not necessarily to scale, and may not represent the actual degree of deflection relative to the door's width. The universal tubes at the top and bottom of each panel section act as primary horizontal reinforcement members, and the clear-span panel bodies flex elastically between the tubes. The corner groove-and-seal interfaces allow relative compression and maintain environmental sealing despite panel deflection.

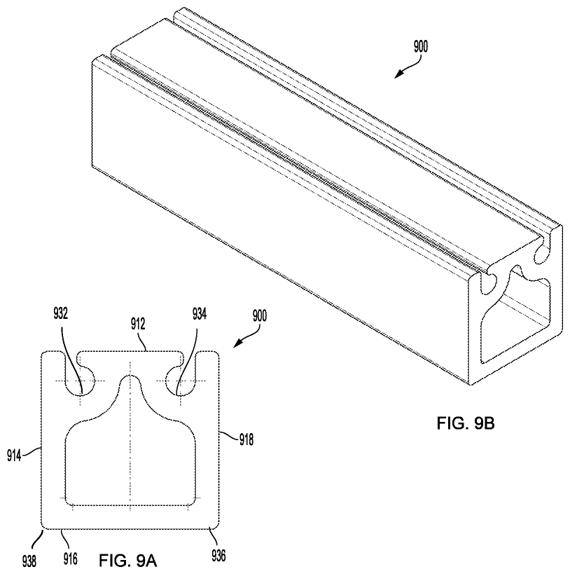

FIGS. 9A and 9B illustrate an alternative embodiment of a universal tube 900 that, in various implementations, may be used in place of or in combination with the universal tubes 100, 600, or 650 previously described. Unlike the embodiments shown in FIGS. 4, 6A, and 6B, which include four corner groove features, the universal tube 900 includes only two corner groove features 932, 934, thereby configured to receive a single seal rather than two seals. For ease of reference, the universal tube embodiment of FIGS. 9A and 9B uses similar numerical identifiers for features corresponding to those of the universal tubes previously described.

In the embodiment shown in FIGS. 9A and 9B, the universal tube 900 includes a first wall 912, a second wall 914 perpendicular to the first wall 912, a third wall 916 parallel to the first wall 912, and a fourth wall 918 parallel to the second wall 914. Corner walls 932 and 934 couple adjacent walls at two corners and cooperatively define grooves at those corners, respectively. The corner grooves are shaped as rounded hooks with a straight throat portion that transitions into a circular capture profile, which is sized to receive and retain a compliant seal. The corner groove geometry is similar, and in some embodiments identical, to the universal tube 100 and 600 geometry to maintain compatibility with seals, panel interfaces, and floor interfaces previously described. In this embodiment, the third wall 916 forms a substantially flat bottom surface without corner groove features, and the opposite side of the tube includes corner walls 936 and 938 that couple adjacent walls without defining seal-receiving grooves.

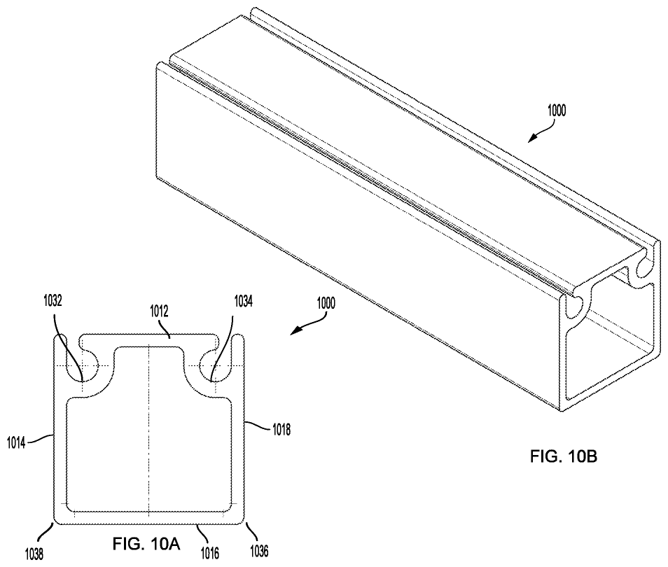

FIGS. 10A and 10B illustrate another alternative embodiment of a universal tube 1000 that likewise includes only two corner groove features configured to receive a single seal. Similar to the embodiment shown in FIGS. 9A and 9B, the universal tube 1000 includes a first wall 1012, a second wall 1014 perpendicular to the first wall 1012, a third wall 1016 parallel to the first wall 1012, and a fourth wall 1018 parallel to the second wall 1014. Corner walls 1032 and 1034 couple adjacent walls at two corners and cooperatively define grooves at those corners, respectively. The corner grooves are shaped as rounded hooks with a straight throat portion that transitions into a circular capture profile, which is sized to receive and retain a compliant seal. In this embodiment, the third wall 1016 forms a substantially flat bottom surface without corner groove features, and the opposite side of the tube includes corner walls 1036 and 1038 that couple adjacent walls without defining seal-receiving grooves.

The two-corner-groove configuration of the universal tubes 900 and 1000 shown in FIGS. 9A-10B may provide certain advantages over the four-corner-groove configuration of the universal tubes 100, 600, and 650. For instance, by eliminating two of the corner groove features, the tubes 900 and 1000 may exhibit increased material volume in the regions where grooves would otherwise be present, thereby providing additional rigidity and strength. The reduced geometric complexity may also facilitate a faster and/or more efficient manufacturing process. In certain applications, the two-groove configuration may be preferred where only a single seal interface is needed, such as at a panel-to-floor interface or at the top or bottom panel of a door assembly where an opposing seal groove is not required.

In certain embodiments, the universal tube embodiments of FIGS. 9A-10B are pultruded fiberglass tubes with a polyurethane resin base, as previously described for tubes 100, 600, and 650. The wall thicknesses may be specified to achieve desired structural performance while maintaining compatibility with existing panel and seal interfaces. In some embodiments, the universal tubes 900 and 1000 may be used in combination with the four-groove universal tubes 100, 600, or 650 within the same door assembly, allowing designers to optimize seal placement and structural performance for specific applications.

In various embodiments, the movable barrier is designed to satisfy structural performance criteria under uniform static air pressure testing in accordance with recognized standards such as ASTM E 330/E330M and ANSI/DASMA 108. For example, a door assembly according to the described embodiments having four clear span panel sections, each approximately 146 inches wide by 24 inches high, with transparent polycarbonate exterior skins and pultruded fiberglass universal tubes, is configured to withstand positive and negative design loads on the order of +30 psf and −30 psf without visible signs of failure and remain operable at the completion of testing. In some embodiments, maximum deflection at elevated test pressures may approach approximately 10-11 inches for certain load levels, while at design pressures in the +30/−30 psf range, peak deflections may be on the order of several inches, all within elastic limits such that the door returns to an operational state after unloading.

In certain embodiments geared to coastal or high-wind markets, the assembly is configured to limit deflection to not more than approximately 12 inches under a design pressure corresponding to a wind speed of at least 160 mph, while maintaining a clear-span panel configuration free of intermediate vertical stiles. To this end, the universal tubes can be specified with increased wall thickness and corner reinforcement (e.g., the geometries shown in FIGS. 6A and 6B), enhanced pultrusion fiber volume fractions, and polyurethane resin systems that elevate stiffness and fatigue resistance. The panels can be further fitted with high-strength end caps, double-wide end cap constructions, and reinforced roller/hinge hardware to maintain alignment and functionality during load reversals typical of cyclic positive and negative pressure events. In some embodiments, the assembly may be configured to deflect more than 12 inches under the design pressure corresponding to a wind speed of at least 160 mph, or may deflect more than 12 inches under a design pressure corresponding to a wind speed of greater than 160 mph. For instance, in some embodiments the assembly is configured to deflect less than about 1.5 inches per linear foot of door span under a design pressure corresponding to a wind speed of 170 mph, 180 mph, 190 mph, or 200 mph.

In various embodiments, the movable barrier exhibits quantified rigidity and structural performance under uniform static air pressure in accordance with recognized standards (e.g., ASTM E330/E330M; ANSI/DASMA 108). In one representative implementation, a four-section door approximately 12 feet in width and 8 feet in height, with transparent polycarbonate skins and pultruded fiberglass universal tubes, is configured to withstand positive and negative design loads of about +30 psf and −30 psf with less than 12 inches of maximum deflection without visible signs of failure and remain operable upon test completion, while the door components (including the tubes) remain within elastic limits such that the assembly returned to service after unloading.

In some aspects, the strength of the door may be described or defined in terms of maximum deflection per unit of horizontal clear span. By way of non-limiting example, for clear spans in the range of approximately 12-16 feet, certain embodiments are configured such that, under a uniform static air pressure difference corresponding to the design loads noted above, the maximum door deflection does not exceed a range of about 0.3-0.9 inches per foot of horizontal clear span. For illustration, a 12-foot clear span at 0.75 inches/foot corresponds to a maximum of about 9 inches, whereas a 16-foot clear span at the same criterion corresponds to about 12 inches. Preferred embodiments may target lower serviceability limits, such as not more than about 0.5-0.6 inches per foot of horizontal clear span at the foregoing design pressures, while alternate embodiments may be engineered for higher design pressures with proportionally similar or reduced deflection per foot.

In one embodiment, a door having a clear span of about 12 feet exhibiting a representative peak deflection of about 6.5-7.5 inches at approximately 30 psf corresponds to about 0.53-0.62 inches per foot; a similar door exhibiting about 6.4-6.9 inches at approximately 34 psf corresponds to about 0.52-0.57 inches per foot. In some non-limiting implementations targeting coastal wind zones, the assembly is configured, for a door of 12 feet of horizontal span, to limit maximum deflection to not more than about 12 inches at a design pressure corresponding to a simulated wind speed of approximately 160 mph, while preserving a clear-span, edge-supported panel architecture without intermediate vertical stiles. In another example, a door having a clear span of 16 feet having the construction described above may be configured to limit deflection of not more than about 16 inches at a design pressure corresponding to a simulated wind speed of approximately 160 mph. In another example, a door having a clear span of 20 feet having the construction described above may be configured to limit deflection of not more than about 20 inches at a design pressure corresponding to a simulated wind speed of approximately 160 mph. As explained above, the peak deflection may be greater for the 12-foot door for design pressures of greater than 30 psf or 34 psf. For instance, the peak deflection of a 12-foot door may be between about 13 and 15 inches for a design pressure corresponding to a wind speed ranging from about 180 to about 200 mph.

These quantified examples are illustrative and do not limit the scope of the disclosure. Other embodiments may be designed for different serviceability targets (e.g., lower maximum deflection per foot, higher design pressures, or both) by adjusting universal tube wall thickness, internal cavity geometry (e.g., rounded plus-shaped or cylindrical), composite fiber volume fraction, resin system, and end cap/roller/bracket reinforcement, while maintaining the same external universal tube interface and seal geometry.

The disclosed configurations deliver structural and aesthetic benefits even at wide door spans, including widths of approximately 16 feet. Structurally, leveraging the universal tubes at the top and bottom edges of each panel section provides a pair of strong, continuous horizontal beams per panel. Coupled with reinforced end caps at the vertical edges and robust track-and-roller support at the jambs, the panels exhibit controlled bending between the beams and define a clear span (also referred to herein as a free span) across the full panel width, without intermediate vertical stiles or intervening vertical supports between opposing vertical edges. This edge-supported, clear-span architecture is desirable because it preserves an uninterrupted, see-through aperture across each panel section, reduces component count and weight, minimizes thermal bridging and debris-catching joints, improves seal continuity at panel interfaces, and allows the use of monolithic transparent or translucent sheet materials without stile breaks, while still meeting wind-load and impact resistance performance targets at widths up to at least about 16 feet. Pultruded fiberglass tubes with polyurethane resin bases offer high specific stiffness, corrosion resistance, and durable performance under repeated load cycles, while the four-corner groove configuration maintains uniform seal retention and allows the same extruded profile to be used at multiple interfaces. Where elevated wind or impact resistance is required, thicker-walled versions of the universal tube with tailored internal cavity geometries—rounded plus-shaped or cylindrical—provide an increased moment of inertia and improved buckling resistance to further reduce deflection and distribute loads.

In various embodiments, universal tubes 100, 600, 650, 900, and/or 1000 are bonded, fastened, or otherwise coupled to panel bodies using structural tape, rivets, bolts, other mechanical fasteners, or combinations thereof, including arrangements that omit through-bolting to preserve optical clarity. Suitable coupling methods include acrylic structural bonding tapes applied along panel edges, mechanical fasteners placed along standardized hole patterns, and/or optional mechanical fasteners at select hinge locations. Mechanical fasteners may include, for instance, blind rivets, carriage bolts, machine screws, pins, threaded inserts, and/or any other suitable types of mechanical fasteners. The tubes may include hole patterns configured to align with panel edges and hardware mounts, and may be sized and spaced to accept industry-standard hinge and bracket geometries.

These implementations can be engineered by selecting tube wall thickness, internal cavity geometry, fiber layup, and resin system to achieve the desired stiffness-to-weight ratio. In some embodiments, universal tubes are produced in multiple standardized wall thickness classes to allow designers to match a given door width, height, and wind zone to a corresponding tube profile while keeping the external geometry and seal interfaces unchanged.

In various embodiments described above, the term “universal tube” encompasses pultruded composite tubes, extruded fiber composite tubes, and equivalent one-piece or integral constructions having substantially rectangular outer profiles with four corner groove features adapted to receive seals. In some embodiments, a “universal tube” may comprise fewer than four groove features, such as those comprising two corner groove features configured to receive a seal. In some aspects, the universal tubes may be used between adjacent panel assemblies and between a bottom panel assembly and the floor, and may serve as attachment points for insulation layers, weatherstripping, or ancillary accessories. The disclosed assemblies can thus provide high rigidity, impact resistance, and wind-load performance—up to and including stringent coastal requirements—while maintaining a clear-span, visually transparent panel architecture without intermediate vertical stiles. In some embodiments, intermediate vertical supports or stiles may be added to the door 10, such as to the panel assemblies 400, to provide for additional stiffness and strength, according to customer specifications and use cases.

It is understood that variations may be made in the foregoing without departing from the scope of the present disclosure. In several exemplary embodiments, the elements and teachings of the various illustrative exemplary embodiments may be combined in whole or in part in some or all of the illustrative exemplary embodiments. In addition, one or more of the elements and teachings of the various illustrative exemplary embodiments may be omitted, at least in part, and/or combined, at least in part, with one or more of the other elements and teachings of the various illustrative embodiments.

Any spatial references, such as, for example, “upper,” “lower,” “above,” “below,” “between,” “bottom,” “vertical,” “horizontal,” “angular,” “upwards,” “downwards,” “side-to-side,” “left-to-right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

In several exemplary embodiments, while different steps, processes, and procedures are described as appearing as distinct acts, one or more of the steps, one or more of the processes, and/or one or more of the procedures may also be performed in different orders, simultaneously and/or sequentially. In several exemplary embodiments, the steps, processes, and/or procedures may be merged into one or more steps, processes and/or procedures.

In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several exemplary embodiments have been described in detail above, the embodiments described are exemplary only and are not limiting, and those skilled in the art will readily appreciate that many other modifications, changes and/or substitutions are possible in the exemplary embodiments without materially departing from the novel teachings and advantages of the present disclosure. Accordingly, all such modifications, changes, and/or substitutions are intended to be included within the scope of this disclosure as defined in the following claims. In the claims, any means-plus-function clauses are intended to cover the structures described herein as performing the recited function and not only structural equivalents, but also equivalent structures. Moreover, it is the express intention of the applicant not to invoke 35 U.S.C. § 112, paragraph 6 for any limitations of any of the claims herein, except for those in which the claim expressly uses the word “means” together with an associated function.

1. A movable barrier assembly comprising:
a plurality of door panels arranged vertically to form a door surface, wherein the door surface comprises a width;
a plurality of cross-tubes extending horizontally across the door surface and coupled to the panels, each cross-tube comprising a fiber composite body having a cross-section, wherein the cross-section is substantially the same for each of the plurality of cross-tubes, and wherein each cross-tube comprises a rectangular profile and a seal member groove at each longitudinally-extending corner; and
wherein the garage door assembly deflects less than one inch per horizontal foot of the width of the door surface under a wind load corresponding to a 160 mph wind speed without the use of intermediate vertical stiffeners between the panels.

2. The movable barrier of claim 1, wherein the fiber composite body comprises a pultruded fiberglass body.

3. The movable barrier of claim 1, wherein each of the cross tubes comprises a first end portion and a second end portion opposite the first end portion, wherein the first end portion is configured to interface with a first roller assembly, and wherein the second end portion is configured to interface with a second roller assembly.

4. The movable barrier of claim 3, further comprising a first rail on a first lateral side of the movable barrier, and a second rail on a second lateral side of the movable barrier, wherein the first roller assembly is configured to engage the first rail, and wherein the second roller assembly is configured to engage the second rail.

5. The movable barrier of claim 1, wherein at least one of the plurality of door panels comprises a clear span of at least 80% of the width of the door.

6. The movable barrier of claim 5, wherein the at least one of the plurality of door panels comprises a flat panel member exhibiting a visible light transmittance (VLT) of at least 80%.

7. The movable barrier of claim 1, wherein the width of the door surface is between 12 feet and 16 feet, and wherein the garage door assembly deflects no more than 11 inches under the wind load corresponding to the 160 mph wind speed.

8. An overhead door assembly comprising:
a plurality of connected panels;
a plurality of reinforcement members extending horizontally across the panels, each reinforcement member comprising a fiber-infused polymeric tube, wherein the fiber-infused plastic tube comprises an elastic limit associated with a maximum deflection;
wherein the overhead door assembly has a width that is greater than its height;
wherein the overhead door assembly is edge supported such that each of the plurality of connected panels comprises a free span of at least 80% of the width of the garage door assembly;
wherein at least one of the plurality of reinforcement members, when the movable barrier assembly is subjected to a design pressure corresponding to a wind speed of at least 160 miles per hour, is configured to deflect while remaining within the elastic limit.

9. The overhead door assembly of claim 8, wherein the width of the overhead door assembly is greater than 11 feet, and wherein the height of the overhead door assembly is greater than 7 feet.

10. The overhead door assembly of claim 9, wherein the movable barrier assembly, when subjected to the design pressure, is configured to deflect no more than 12 inches, wherein the elastic limit of the fiber-infused polymeric tube allows for greater than 12 inches of deflection.

11. The overhead door assembly of claim 8, wherein the fiber-infused polymeric tube comprises a pultruded fiberglass body.

12. The overhead door assembly of claim 8, wherein each of the horizontal reinforcement members comprises a first end portion and a second end portion opposite the first end portion, wherein the first end portion is configured to interface with a first roller assembly, and wherein the second end portion is configured to interface with a second roller assembly.

13. The overhead door assembly of claim 12, further comprising a first rail on a first lateral side of the overhead door assembly, and a second rail on a second lateral side of the overhead door assembly, wherein the first roller assembly is configured to engage the first rail, and wherein the second roller assembly is configured to engage the second rail.
